(19) United States
(12) Patent Application Publication
(10) Pub. No.: US 2006/0114623 A1
(43) Pub. Date: Jun. 1, 2006

(54) Switching type power source device and magnetio resonance imaging device using the same

(76) Inventors: Takuya Domoto, Chiba (JP); Hiroshi Takano, Ibaraki (JP)

Correspondence Address: COOPER & DUNHAM, LLP, 1185 AVENUE OF THE AMERICAS, NEW YORK, NY, 10036, US

(21) Appl. No.: 10/542,796

(22) PCT Filed: Feb. 6, 2004
(86) PCT No.: PCT/JP04/01292

§ 371 Date: Jul. 19, 2005

(30) Foreign Application Priority Data
Feb. 12, 2003 (JP) 2003-33173

(51) Int. Cl. H02H 7/00

(52) U.S. Cl. 361/18

(57) ABSTRACT

A switching type power source device used for magnetic field generation coils for an MRI device in which a switching power sources (9˜11) are constituted by a first and a second multi level PWM inverter (12,13) having a same number of potential levels connected in parallel each other with respect to magnetic field generating coils (6˜8) for the MRI device working as a load as well as a switching control circuit (19) for drive controlling the first and the second multi level PWM inverter (12,13) is constituted to drive control the first and the second multi level PWM inverter (12,13) in a manner to shift the switching phases thereof each other, thereby, ripple components in currents output from the first and the second multi level PWM inverter (12,13) are canceled out each other and a current with a further reduced ripple components as a whole can be supplied to the load (6˜8).

### FIELD OF THE INVENTION

The present invention relates to a switching type power source device suitable for magnetic field generation use coils namely, static magnetic field, gradient magnetic field or high frequency magnetic field generation use coils for a magnetic resonance imaging device (herein after MRI device) which requires a high current accuracy and comparatively high voltage and large current, for example, 1000˜2000V and 500 A, and an MRI device using the same.

### CONVENTIONAL ART

Switching type power sources have been largely used as power source devices for MRI devices, and recently, in response to a demand for increasing current thereof, a power source device for magnetic field generation use coils for an MRI device formed by connecting two level PWM inverters in parallel as disclosed, for example, in JP-A-8-211139 has been known. Further, in a field of inverter power sources for driving three phase motors, multi level inverter technology has been drawing attention for rising voltage and increasing current and for counter measuring to high harmonic components as disclosed, for example, in Jose Rodriguez et al. “Multilevel Inverters: A Survey of Topologies, Control, and Applications” (IEEE TRANSACTION ON INDUSTRIAL ELECTRONICS, VOL. 49, No. 4, August 2002, pp 724˜738).

Although now a day power source devices for MRI devices are required of rising the voltage and increasing the current for high speed imaging, however, even when the above referred to multi level PWM inverters are used for a switching power source, a current ripple is still caused during the switching operation, the accuracy of the current being supplied to magnetic field generation use coils working as a load is decreased, which prevents from acquiring high quality MRI images.

### SUMMARY OF THE INVENTION

An object of the present invention is to provide a high voltage and large current switching type power source device with further reduced current ripple and an MRI device using the same.

For achieving the above object, the present invention provides a switching type power source device for magnetic field generation coils used for an MRI device in which a switching power source is constituted by a first and a second multi level PWM inverter having a same number of potential levels and being connected in parallel relation each other with respect to each of the magnetic field generation coils for the MRI device working as a load as well as a switching control circuit for drive controlling the first and the second multi level PWM inverter is constituted to drive control switching phases of the first and the second multi level PWM inverter in a manner to shift each other, thereby, ripples of currents output from the first and the second multi level PWM inverter are canceled out each other and a current with further reduced ripple components as a whole can be supplied to the load.

### BRIEF DESCRIPTION OF THE DRAWINGS

FIG. 1 is a block constitutional diagram of an MRI device use power source device according to one embodiment of the present invention;

FIG. 2 is a circuit diagram of a multi level diode clamp type PWM inverter used for the MRI device use power source device as shown in FIG. 1;

FIG. 3 is voltage and current output waveform diagrams of respective multi level diode clamp type PWM inverters as shown in FIG. 2 connected in parallel each other and a summed output current waveform diagram thereof;

FIG. 4 is a characteristic diagram showing output current waveform for comparison of a conventional two level inverter and of a conventional five level inverter; and

FIG. 5 is a block diagram showing an internal structure of a switching circuit 19 as shown in FIG. 1.

### DETAILED DESCRIPTION OF THE EMBODIMENT

An embodiment of the present invention will be explained with reference to the drawings.

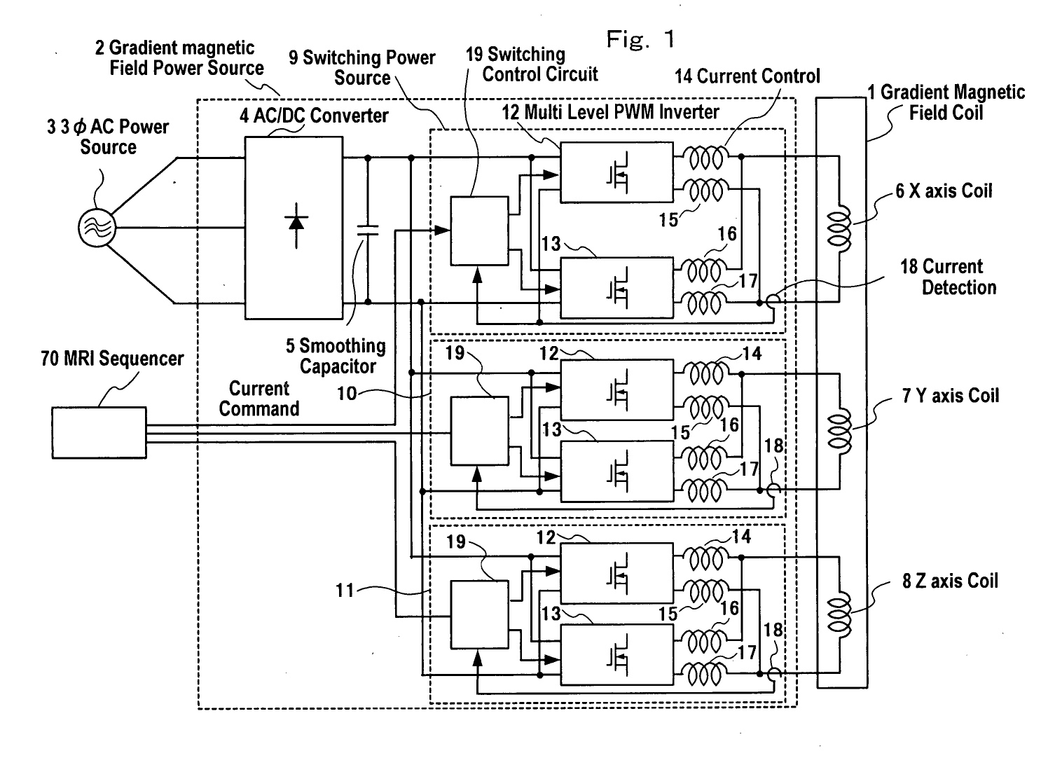

FIG. 1 shows a block constitutional diagram when a switching type power source device according to one embodiment of the present invention is applied to gradient magnetic field coils for an MRI device.

A gradient magnetic field coil use power source device 2 for the MRI device is constituted in a manner being supplied of an electric power from a three phase AC power source 3 and connected to a gradient magnetic field use coil 1 working as a load to supply a current thereto. The gradient magnetic field coil use power source device 2 for the MRI device is provided with an AC/DC converter 4 which is connected to the three phase AC power source 3 and converts a three phase AC voltage to a DC voltage, a smoothing capacitor 5 which is connected to the output side of the AC/DC converter 4 and smoothes the DC voltage and switching power sources 9˜11 functioning as current amplifiers which are connected to the smoothing capacitor 5 to receive the smoothed DC voltage and supply a current respectively to an X axis coil 6, a Y axis coil 7 and a Z axis coil 8 in the gradient magnetic field use coil 1.

The switching power source 9 is constituted by two multi level PWM inverters 12 and 13 which are respectively connected at the input sides thereof and in parallel to the smoothing capacitor 5 representing DC voltage source, current limiting means 14˜17 which are respectively connected at the output sides of the multi level PWM inverters 12 and 13 and connected in series with the X axis coil 6 in the gradient magnetic field use coil 1 working as the load, a current detection means 18 for detecting an output current of the switching power source 9 and a switching control circuit 19 which is input of a current command value from a sequencer 70 for the MRI device and of a current detection value output from the current detection means 18 and drive controls the multi level PWM inverters 12 and 13 so that the difference of both values assumes zero, and the switching control circuit 19 is provided with a control function for shifting switching phases of the two multi level PWM inverters 12 and 13 connected in parallel to cancel out output current ripples.

Since the constitution of the switching power sources 10 and 11 which are respectively connected to the Y axis coil 7 and Z axis coil 8 in the gradient magnetic field use coil 1 is the same as that of the switching power source 9 as has been explained above, by merely pointing out the above fact, the duplicating explanation thereof is omitted.

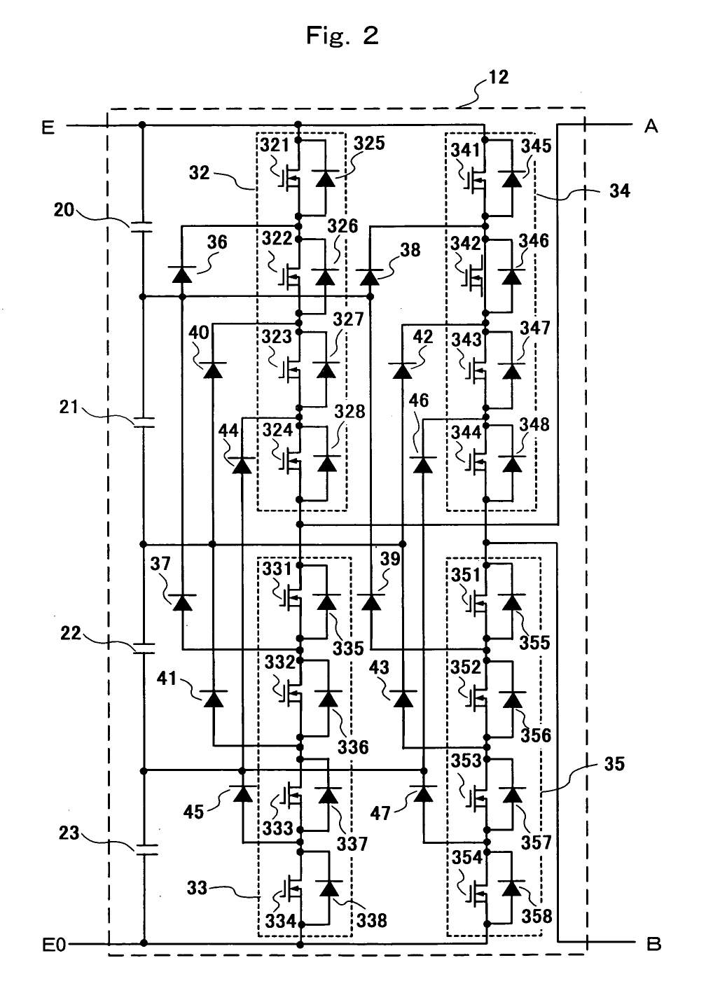

FIG. 2 is a circuit diagram of a five level diode clamp type PWM inverter as an example of the multi level PWM inverters 12 and 13.

The five level diode clamp type PWM inverter is constituted in such a manner that at the inputs thereof DC power sources E and E0 are connected and at output terminals A and B thereof outputs of any desired voltage waveforms are output. At the sides of DC voltage sources E and E0 of the five level diode clamp type PWM inverter voltage dividing capacitors 20˜23 are connected to divide the DC voltage into four (E/4), and the five level diode clamp type PWM inverter includes four sets of arms 32˜35 each of which is constituted by four pair of MOSFETs representing semiconductor switches 321˜324, 331˜334, 341˜344 and 351˜354 and diodes 325˜328, 335˜338, 345˜348 and 355˜358 connected in anti parallel each other and by connecting the same in series, and the four arms are connected in a full bridge. Between a junction between the voltage dividing capacitors 20 and 21 and respective junctions between the semiconductor switches 321, 331, 341 and 351 and the semiconductor switches 322, 332, 342 and 352 of the respective arms 32˜35 in the full bridge structure, voltage clamping use diodes 36˜39 are respectively connected. Further, between a junction between the voltage dividing capacitors 21 and 22 and respective junctions between the semiconductor switches 322, 332, 342 and 352 and the semiconductor switches 323, 333, 343 and 353 of the respective arms 32˜35, voltage clamping use diodes 40˜43 are respectively connected. Likely, between a junction between the voltage dividing capacitors 22 and 23 and respective junctions between the semiconductor switches 323, 333, 343 and 353 and the semiconductor switches 324, 334, 344 and 354, voltage clamping use diodes 44˜47 are respectively connected.

Herein, with the switching control circuit 19, when the semiconductor switches 321˜324 in the arm 32 are rendered conductive, a voltage +E can be output at the output terminal A, when the semiconductor switches 322˜324 in the arm 32 and the semiconductor switch 331 in the arm 33 are rendered conductive, a voltage +E·¾ can be output at the output terminal A, when the semiconductor switches 323, 324 in the arm 32 and the semiconductor switch 331, 332 in the arm 33 are rendered conductive, a voltage +E·½ can be output at the output terminal A, when the semiconductor switches 324 in the arm 32 and the semiconductor switch 331˜333 in the arm 33 are rendered conductive, a voltage +E·¼ can be output at the output terminal A, and further, when the semiconductor switch 331˜334 in the arm 33 are rendered conductive, a voltage 0 can be output at the output terminal A, thus five levels voltage output can be obtained at the output terminal A.

Further, in the same manner, with regard to the output terminal B, when the semiconductor switches 341˜344 in the arm 34 are rendered conductive, a voltage +E can be output at the output terminal B, when the semiconductor switches 342˜344 in the arm 34 and the semiconductor switch 351 in the arm 35 are rendered conductive, a voltage +E·¾ can be output at the output terminal B, when the semiconductor switches 343, 344 in the arm 34 and the semiconductor switch 351, 352 in the arm 35 are rendered conductive, a voltage +E·½ can be output at the output terminal B, when the semiconductor switches 344 in the arm 34 and the semiconductor switch 351˜353 in the arm 35 are rendered conductive, a voltage +E·¼ can be output at the output terminal B, and further, when the semiconductor switch 351˜354 in the arm 35 are rendered conductive, a voltage 0 can be output at the output terminal B, thus, five levels voltage output can be obtained also at the output terminal B.

Accordingly, when noting the voltage difference between the output terminals A and B, nine kinds of voltages of −E, −E·¾, −E/2, −E·¼, 0, +E·¼, +E/2, +E·¾ and +E can be obtained.

Further, by subjecting these voltages to PWM modulation, any desired voltages from −E to +E corresponding to double voltage between E and E0 can be output.

In the respective multi level PWM inverters 12 and 13, since the voltage of the DC voltage source is divided by the dividing capacitors 20˜23 and likely by the semiconductor switches 321˜324, 331˜334, 341˜344 and 351˜354 in the respective arms 32˜34 and the voltage clamping use diodes 36˜47 are connected to the respective junctions of the semiconductor switches, only the divided DC voltage is applied to the respective semiconductor switches 321˜324, 331˜334, 341˜344 and 351˜354, therefore, even if semiconductor switches having a low withstanding voltage are used, a high output voltage can be obtained. Further, since the multi level PWM inverters 12 and 13 are used for the switching power sources 9˜11 functioning as current amplifiers, possible current ripples can be reduced when comparing with a conventional two level PWM inverters.

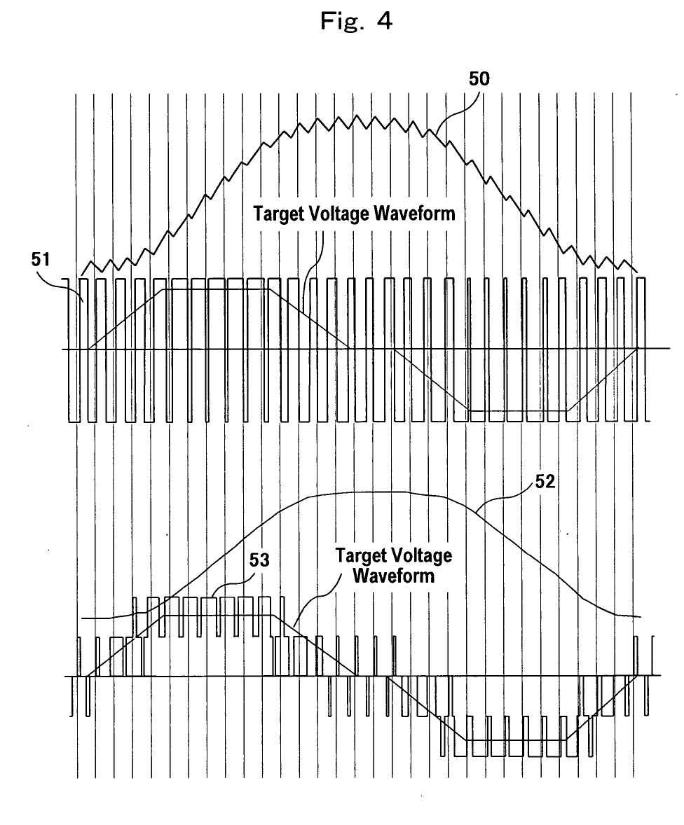

FIG. 4 is schematic waveform diagrams of voltage and current of a conventional two level inverter and a conventional five level inverter, which is employed in the embodiment of the present invention.

Since an output current waveform 50 in the conventional two level inverter is obtained from two potentials of positive and negative such as shown as an output voltage waveform 51, the current variation when the voltage as shown by the output waveform 51 is applied is extreme, as a result, the current ripples are enlarged. On the other hand, since an output current waveform 52 in the conventional five level inverter is obtained from five potentials such as shown as an output voltage waveform 53, the current variation due to five potentials as shown by the output waveform 53 is very gentle, as a result, the current ripples are reduced when compared with those of the conventional two level inverter.

Now, an advantage will be explained of using the multi level PWM inverters connected respectively in parallel for the switching power sources 9˜11 functioning as current amplifiers.

As shown in FIG. 1, in the gradient magnetic field use power source device 2 for the MRI device, the multi level diode clamp type PWM inverters 12 and 13 as shown in FIG. 2 connected in parallel are used and at the output sides thereof current control means 14˜17 such as reactors are connected in series with respect to the load. The switching control circuit 19 is provided with a control function which performs drive control by shifting the switching phases of the two multi level diode clamp type PWM inverters 12 and 13 so that the difference between the current command value from the sequencer 70 and the current detection value from the current detection means 18 assumes zero, which will be explained below specifically. With this parallel structure of the inverters, not only the output current can be increased, but also with the shifting of the switching phases, for example, when the operation is performed while shifting the switching phase by 180°, the current ripples are reduced further extremely as will be explained herein below.

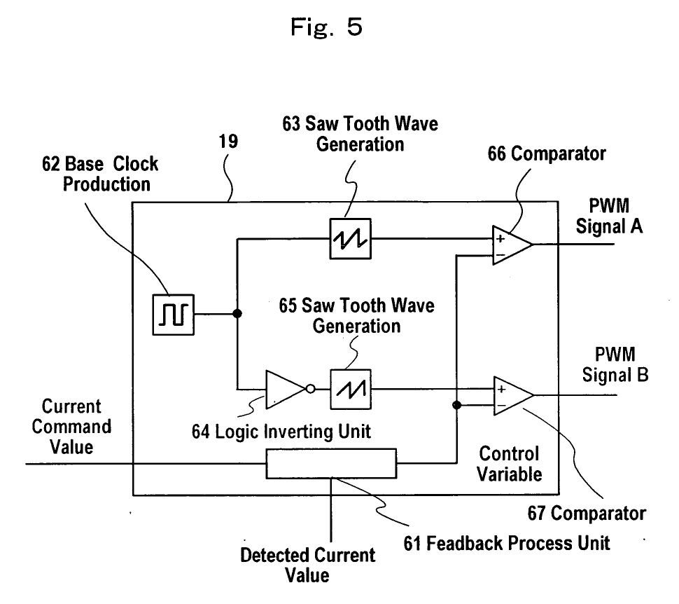

FIG. 5 shows, as an example of the switching control circuit 19, a schematic diagram of a control circuit which operates the inverters while shifting the switching phases by 180°. The control circuit 19 is input of the current command value and the current detection value and outputs a PWM signal A and a PWM signal B for performing the operation while shifting the switching phases by 180° each other. The current command value and the current detection value are input to a feedback process unit 61. The feedback process unit 61 performs processing so that the difference between the current command value and the current detection value assumes zero and outputs a control variable corresponding thereto. Further, a base clock producing means 62 produces base clocks having a frequency equal to the switching frequency at duty of 50%, and the output thereof is connected to a saw tooth wave generation means 63 and to another saw tooth wave generation means 65 via a logic inverting unit 64. With the saw tooth wave generation means 63 and 65, saw tooth waves of which phases are shifted by 180° each other are produced and are output respectively to comparators 66 and 67. The comparators 66 and 67 receive the saw tooth waves from the saw tooth wave generation means 63 and 65 and the control variable from the feedback process unit 61 and compare the same, and output the PWM signal A and the PWM signal B.

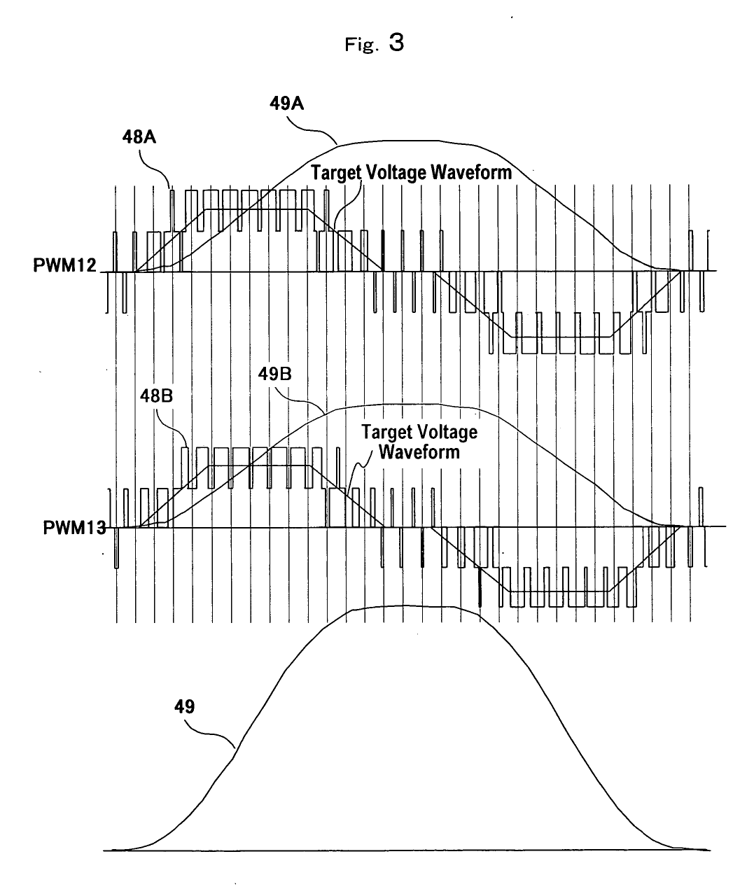

FIG. 3 shows voltage output waveforms 48A and 48B and current output waveforms 49A and 49B, when the five level diode clamp type PWM inverters are used for the multi level PWM inverters 12 and 13 as well as the PWM control is performed while shifting the switching phases between both by 180°. Further, a curve 49 represents a summed output current waveform formed by overlapping the output current waveforms 49A and 49B, and it is observed that by shifting the switching phases of both inverters the current ripples are extremely reduced as a whole.

As explained in connection with FIG. 4, the five level diode clamp type PWM inverter by itself can operate with the output current waveform having reduced current ripples when compared with the two level inverter, however, in association with the variations in the output voltage waveforms 48A and 48B, some current ripples are still observed. On the other hand, since the switching control circuit 19 of the present invention is provided with the control function of drive control for shifting the switching phases between the two multi level PWM inverters 12 and 13 so that the difference between the command current value and the current detection value from the current detection means 18 assumes zero, the current ripples between the multi level PWM inverters of which phases are shifted by 180° are canceled out each other, thereby, a current output with a reduced ripples can be obtained. For this ripple canceling out effect, the phase shifting of 180° is preferable, however, the amount of phase shifting is not limited thereto, the current ripple reduction can be obtained when the switching phases between the two multi level PWM inverters 12 and 13 are substantially shifted.

As a power source device used for an MRI device, it is important that the same can output a high voltage and a large current with reduced dv/dt noises and reduced current ripples. Through the use of the plurality of multi level PWM inverters 12 and 13 connected in parallel, a high voltage and a large current output is realized and further, with the drive control for shifting each other the switching phases of the multi level PWM inverters connected in parallel, the reduced dv/dt noises and the reduced current ripples are realized.

Further, in the above explained embodiment, as the multi level PWM inverters 12 and 13, the five level diode clamp type PWM inverter was exemplified and explained by making use of the same, however, the present invention is not limited thereto, and a multi level PWM inverter having more than two levels can be applicable, in that the more the number of levels increases, the more higher output voltage, the more reduced dv/dt noises and the more reduced current ripples are possible, on the other hand, the number of the semiconductor switches increases and the size of the inverter enlarges. Further, although an example of using an MOSFET for the semiconductor switch has been explained, such as a bipolar transistor, an IGBT, a GTO and a thyristor can be used for the semiconductor switch. Further, the operation of two sets of multi level PWM inverters connected in parallel with phase shifting of 180° has been explained, however, if a plurality of inverters are connected in parallel and operated with substantial phase shifting, the current ripples can be reduced. Still further, although the reactors are exemplified for the current limiting means 14˜17, resistors can be used therefor. Still further, with regard to the AC/DC converter 4, the smoothing capacitor 5 and the three phase AC power source 3, the system does not limited thereto, if the same operates as a DC power source which applies a DC voltage to the switching power sources 9˜11 working as current amplifiers. Moreover, as the load to which the switching type power source device is connected, the gradient magnetic field use coils for the MRI device has been explained, the switching type power source device can be used and connected to coils which generate static magnetic field or high frequency magnetic field as the load thereof.

1. A switching type power source device comprising:
a first and a second switching power source connected in parallel each other with respect to a load;
a current detection unit for detecting a current supplied to the load from the first and the second switching power source; and
a switching control circuit which receives a command value of current to be supplied to the load and a detected current value from the current detection unit and drive controls the first and the second switching power source so that difference of both values assumes zero,
wherein the first and the second switching power source are respectively constituted by a multi level PWM inverter having a same number of potential levels and the switching control circuit further drive controls the first and the second multi level PWM inverter connected in parallel each other so that the switching phases thereof are shifted each other.

2. A switching type power source device according to claim 1, wherein the first and the second multi level PWM inverter are respectively a multi level diode clamp type PWM inverter.

3. A switching type power source device according to claim 1, wherein the switching control circuit produces a first PWM switching signal to be supplied to the first multi level PWM inverter and a second PWM switching signal to be supplied to the second multi level PWM inverter and the phases of the first and the second PWM switching signal are shifted each other so that ripple components in the sum of output current containing ripples output respectively from the first and the second multi level PWM inverter connected in parallel are reduced as a whole.

4. A switching type power source device according to claim 3, wherein the phases of the first and the second PWM switching signal supplied respectively to the first and the second multi level PWM inverter from the switching control circuit are shifted by 180° each other.

5. A switching type power source device according to claim 1, wherein the switching control circuit includes a first comparator which supplies the first multi level PWM inverter the first PWM switching signal, a second comparator which supplies the second multi level PWM inverter the second PWM switching signal, a base clock producing means, a first saw tooth wave generating means which inputs a saw tooth wave to a first input terminal of the first comparator based on clocks from the base clock producing means, a second saw tooth wave generating means which receives clocks from the base clock producing means through a logic inverting unit and inputs the inverted saw tooth wave to a first input terminal of the second comparator and a feedback process unit which receives the current command value and the detected current value, processes a control variable which renders the difference of both values zero and outputs the same to second input terminals of the first and the second comparator.

6. A switching type power source device according to claim 2, wherein each of the multi level diode clamp type PWM inverters is constituted by a first and a second arm connected in series and a third and a fourth arm connected in series and both connected between a DC power source, a first, second, . . . n−1th and nth (wherein n is an integer more than 1) voltage dividing capacitor likely connected between the DC power source, a first, second, . . . n−1th and nth semiconductor switch connected in series and diodes connected in anti parallel to the first, second, . . . n−1th and nth semiconductor switch which constitute each of the first, the second, the third and the fourth arm and voltage clamp use diodes respectively connected between a junction between the first and the second voltage dividing capacitor and junctions between the first and the second semiconductor switch in the respective arms, . . . voltage clamp use diodes respectively connected between a junction between the n−1th and the nth voltage dividing capacitor and junctions between the n−1th and the nth semiconductor switch in the respective arms.

7. A magnetic resonance imaging device provided with the switching type power source device according to any one of claims 1 through 6, wherein the load is gradient magnetic field use coils for the magnetic resonance imaging device.

8. A magnetic resonance imaging device according to claim 7, wherein the current command value is sent from a sequencer of the magnetic resonance imaging device.
